(19) United States
(12) Patent Application Publication
(10) Pub. No.: US 2019/0351463 A1
(43) Pub. Date: Nov. 21, 2019

(54) ELECTRIC TOOTHBRUSH WITH A TOOTHPASTE CARTRIDGE

(71) Applicant: Susheel Wupendram, Tempe, AZ (US)

(72) Inventor: Susheel Wupendram, Tempe, AZ (US)

(21) Appl. No.: 16/416,215

(22) Filed: May 18, 2019

Related U.S. Application Data
(60) Provisional application No. 62/673,902, filed on May 19, 2018.

(51) Int. Cl. B08B 7/00; A46B 5/00; A46B 11/00; A46B 15/00; A61C 17/22; A46B 17/04

(52) U.S. Cl. CPC B08B 7/0057; A46B 5/0095; A46B 11/0041; A46B 17/04; A61C 17/221; A61C 17/224; A61C 17/227; A46B 15/0044

(57) ABSTRACT

Disclosed herein is an electric toothbrush with a toothpaste cartridge. The electric toothbrush may include a main body with a top end adapted to engage with a removable brush attachment. The main body may be configured to accommodate the toothpaste cartridge, one or more conduits, a servo mechanism, a controller, and an energy storage device. The removable brush attachment having an elongated structure configured to be removably attached to the main body. The elongated structure may include a first end including a brush head with a front surface. The front surface may include one or more openings configured to dispense a fluid flowing through a passage within the removable brush attachment. The toothpaste cartridge having a flexible cylindrical tank configured for storing the fluid, and to release the fluid into the one or more conduits when a pressure may be applied to the toothpaste cartridge by the servo mechanism.

### RELATED APPLICATION(S)

Under provisions of 35 U.S.C. § 119e, the Applicant(s) claim the benefit of U.S. provisional application No. 62/673,902 filed May 19, 2018, which is incorporated herein by reference

### TECHNICAL FIELD

Generally, the present disclosure relates to the field of dentistry. More specifically, the present disclosure relates to an electric toothbrush with a toothpaste cartridge.

### BACKGROUND

Every day, millions of people around the world use electric toothbrushes. Squeezing a tube of toothpaste such that a small amount is applied to the toothbrush is a slow, tedious task and often results in waste. A self-loading electric toothbrush would be very useful and would be well received.

Therefore, there is a need for improved electric toothbrush with a toothpaste cartridge that may overcome one or more of the above-mentioned problems and/or limitations.

### BRIEF SUMMARY

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is an electric toothbrush with a toothpaste cartridge, in accordance with some embodiments. Accordingly, the electric toothbrush may include a main body having a hollow cylindrical section with a top end and a bottom end. Further, the top end may be adapted to engage with a removable brush attachment. Further, the bottom end may be adapted to engage with a removable end cap. Further, the main body may be configured to accommodate the toothpaste cartridge, one or more conduits, a servo mechanism, a controller, and an energy storage device within the hollow cylindrical section. Further, the servo mechanism may be electrically coupled with the energy storage device through the controller. Further, an outer surface of the main body may include a plurality of control buttons, one or more indicating devices, and a charging socket.

Further, the electric toothbrush may include the removable brush attachment having an elongated structure configured to be removably attached to the main body. Further, the elongated structure may include a first end and a second end. Further, the first end may include a brush head with a front surface. Further, one or more bristles may extend outward from the front surface with one end of the one or more bristles attached to the front surface of the brush head. Further, the front surface may include one or more openings configured to dispense a fluid flowing through a passage within the removable brush attachment. Further, the passage may be adapted to engage with the one or more conduits when the second end of the removable brush attachment may be in contact with the top end of the main body.

Further, the electric toothbrush may include the toothpaste cartridge having a flexible cylindrical tank configured for storing the fluid. Further, the toothpaste cartridge may be mechanically coupled with the one or more conduits configured to allow the fluid to flow from the toothpaste cartridge to the passage via the one or more conduits. Further, the flexible cylindrical tank may be configured to release the fluid into the one or more conduits when a pressure may be applied to the toothpaste cartridge by the servo mechanism.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an exploded front view of an electric toothbrush with a toothpaste cartridge, in accordance with some embodiments.

FIG. 2 is an exploded rear view of an electric toothbrush, in accordance with some embodiments.

FIG. 3 is an exploded bottom perspective view of an electric toothbrush, in accordance with some embodiments.

FIG. 4 is an exploded top perspective view of an electric toothbrush, in accordance with some embodiments.

FIG. 5 is a front view of an electric toothbrush, in accordance with some embodiments.

FIG. 6 is a rear view of an electric toothbrush, in accordance with some embodiments.

FIG. 7 is a left side perspective view of an electric toothbrush, in accordance with some embodiments.

FIG. 8 is a right side perspective view of an electric toothbrush, in accordance with some embodiments.

FIG. 9 is a bottom perspective view of an electric toothbrush, in accordance with some embodiments.

FIG. 10 is an exploded left side perspective view of an electric toothbrush, in accordance with some embodiments.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of electric toothbrush with a toothpaste cartridge, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

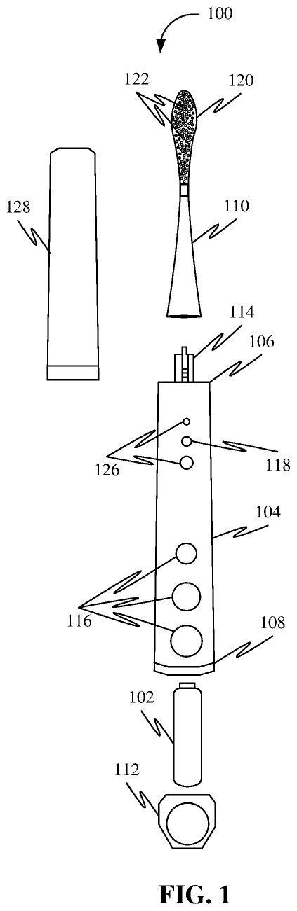

FIG. 1 is an exploded front view of an electric toothbrush 100 with a toothpaste cartridge 102, in accordance with some embodiments. Accordingly, the electric toothbrush 100 may include a main body 104 having a hollow cylindrical section with a top end 106 and a bottom end 108. Further, the top end 106 may be adapted to engage with a removable brush attachment 110. Further, the bottom end 108 may be adapted to engage with a removable end cap 112. Further, the main body 104 may be configured to accommodate the toothpaste cartridge 102, one or more conduits 114, a servo mechanism (not shown), a controller (not shown), and an energy storage device (not shown) within the hollow cylindrical section. Further, the servo mechanism may be electrically coupled with the energy storage device through the controller. Further, an outer surface of the main body 104 may include a plurality of control buttons 116, one or more indicating devices 126, and a charging socket 118. Further, the charging socket 118, in an instance, may allow a user to charge the energy storage device by electrically connecting an outside electrical source to the charging socket 118.

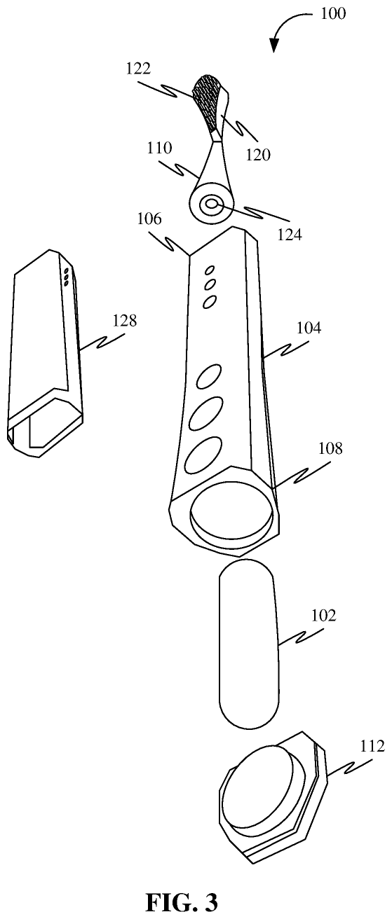

Further, the electric toothbrush 100 may include the removable brush attachment 110 having an elongated structure configured to be removably attached to the main body 104. Further, the elongated structure may include a first end and a second end. Further, the first end may include a brush head 120 with a front surface. Further, one or more bristles 122 may extend outward from the front surface with one end of the one or more bristles 122 attached to the front surface of the brush head 120. Further, the front surface may include one or more openings configured to dispense a fluid flowing through a passage 124 (as shown in FIG. 3) within the removable brush attachment 110. Further, the passage 124 may be adapted to engage with the one or more conduits 114 when the second end of the removable brush attachment 110 may be in contact with the top end 106 of the main body 104.

Further, the electric toothbrush 100 may include the toothpaste cartridge 102 having a flexible cylindrical tank configured for storing the fluid. Further, the toothpaste cartridge 102 may be mechanically coupled with the one or more conduits 114 configured to allow the fluid to flow from the toothpaste cartridge 102 to the passage 124 via the one or more conduits 114. Further, the flexible cylindrical tank may be configured to release the fluid into the one or more conduits 114 when a pressure may be applied to the toothpaste cartridge 102 by the servo mechanism.

Further, in some embodiments, the servo mechanism may include a servo motor, and a rack and pinion arrangement. Further, the servo motor may be mechanically coupled with the rack and pinion arrangement. Further, the rack and pinion arrangement may be configured to convert a rotational motion of the servo motor into a linear motion to apply the pressure to the toothpaste cartridge 102.

Further, in some embodiments, the fluid may include a toothpaste.

Further, in some embodiments, the plurality of control buttons 116 may include at least one of a variable speed button, a sanitizing button, an on/off button, and a toothpaste dispensing button. Further, in some embodiments, the controller may be configured to allow the flow of electrical energy from the energy storage device to the servo mechanism when the toothpaste dispensing button may be pressed.

Further, in some embodiments, the one or more indicating devices 126 may include a display device. Further, the display device may be configured to display a visual content. Further, the visual content may include a smiling emoticon when a user may be holding the electric toothbrush in a correct position. Further, in some embodiments, the display device may be configured to display a numerical value corresponding to at least one of a charge amount left in the energy storage device, and a fluid amount left in the toothpaste cartridge 102. Further, in some embodiments, the display device may include at least one of a seven-segment display, a nine-segment display, a fourteen-segment display, and a sixteen-segment display.

Further, in some embodiments, the one or more indicating devices 126 may include one or more Light Emitting Diodes (LEDs). Further, the one or more LEDs may be configured to illuminate one or more colors indicating at least one of an empty toothpaste cartridge 102, and a drained-out energy storage device.

Further, in some embodiments, the energy storage device may include at least one of a Lithium-ion battery, a Nickel-Cadmium battery, a Lead-Acid battery, and a Nickel-Metal hydride battery.

Further, in some embodiments, the toothpaste cartridge 102 may be manufactured using at least one of plastic, thermoplastic polymers, elastomers, thermoplastic elastomers, and aluminum.

Further, in some embodiments, the main body 104 may be manufactured using at least one of a plastic, a copper alloy, a steel, and an aluminum alloy.

Further, in some embodiments, the one or more bristles 122 may be manufactured using nylon.

Further, in some embodiments, the removable end cap 112 may be configured to secure the toothpaste cartridge 102 within the hollow cylindrical section of the main body 104.

Further, in some embodiments, the top end 106 of the main body 104 may be adapted to engage with a removable upper cap 128. Further, the removable upper cap 128 may be configured to cover the removable brush attachment 110 when the electric toothbrush 100 may not be in use. Further, in some embodiments, the outer surface of the main body 104 may include a latch 130 configured to removably secure the removable upper cap 128 with the top end 106 of the main body 104. Further, in some embodiments, the removable upper cap 128 may include an Ultraviolet light sanitizer. Further, in some embodiments, the ultraviolet light sanitizer may be electrically coupled with the energy storage device through the controller. Further, in some embodiments, the controller may be configured to allow the flow of electrical energy from the energy storage device to the ultraviolet light sanitizer for a predetermined period when the removable upper cap 128 may be engaged with the top end 106 of the main body 104. Further, the predetermined period may be at least 30 seconds. Further, in some embodiments, the controller may be configured to allow the flow of electrical energy from the energy storage device to the ultraviolet light sanitizer when a sanitizing button may be pressed. Further, the sanitizing button, in an instance, may be disposed on the outer surface of the main body 104.

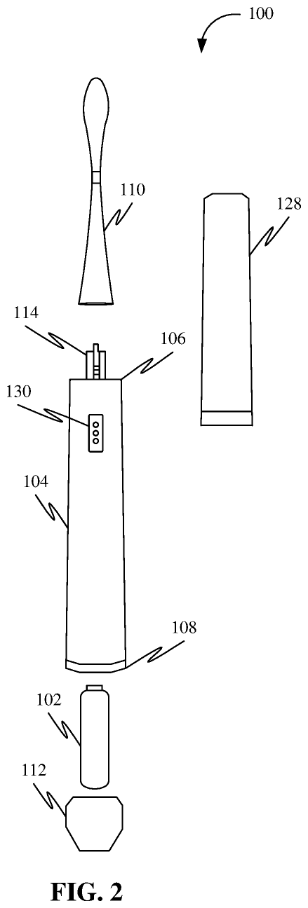

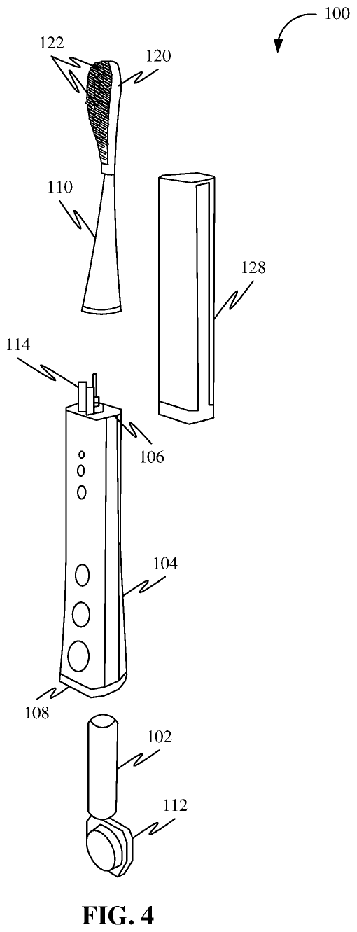

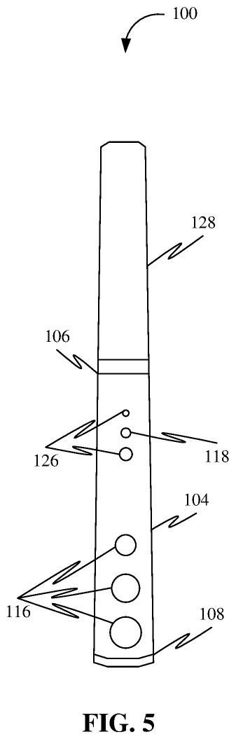

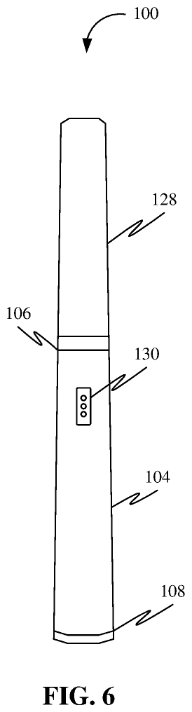

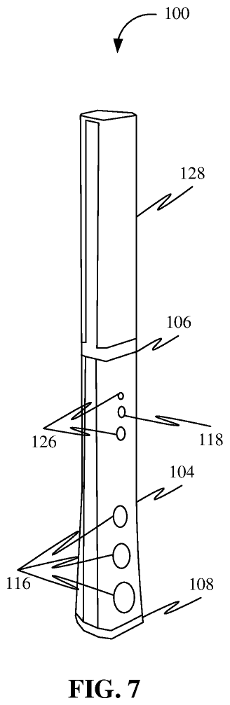

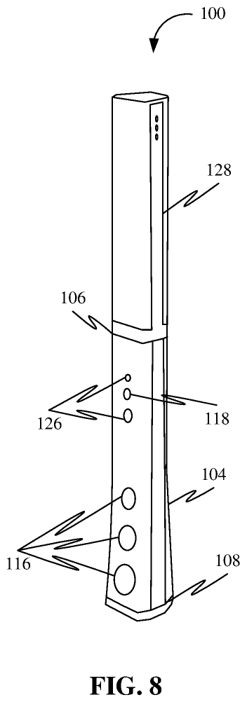

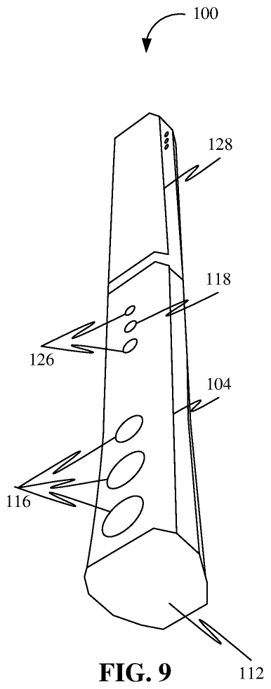

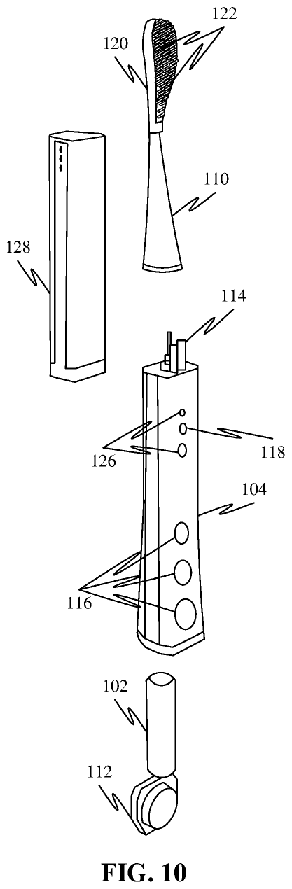

Further, FIG. 2 is an exploded rear view of the electric toothbrush 100, in accordance with some embodiments. Further, FIG. 3 is an exploded bottom perspective view of the electric toothbrush 100, in accordance with some embodiments. Further, FIG. 4 is an exploded top perspective view of the electric toothbrush 100, in accordance with some embodiments. Further, FIG. 5 is a front view of the electric toothbrush 100, in accordance with some embodiments. Further, FIG. 6 is a rear view of the electric toothbrush 100, in accordance with some embodiments. Further, FIG. 7 is a left side perspective view of the electric toothbrush 100, in accordance with some embodiments. Further, FIG. 8 is a right side perspective view of the electric toothbrush 100, in accordance with some embodiments. Further, FIG. 9 is a bottom perspective view of the electric toothbrush 100, in accordance with some embodiments. Further, FIG. 10 is an exploded left side perspective view of the electric toothbrush 100, in accordance with some embodiments.

Further, in some embodiments, an electric toothbrush 100 may provide an upper cap (such as the removable upper cap 128) which may cover a removable, bristled head attachment (such as the removable brush attachment). Further, the electric toothbrush 100 may include a handle (such as the main body 104), which may provide a latch (such as the latch 130) on a rear surface to secure the upper cap and a plurality of control buttons (such as the plurality of control buttons 116) and a recharging socket (such as the charging socket 118) on a front surface. Further, the electric toothbrush 100 may include a bottom endcap (such as the removable end cap 112). The plurality of control buttons may include a variable speed button, a sanitizing button, an on/off button, and a toothpaste dispensing button.

Further, pressing the toothpaste dispensing button may cause a predetermined amount of toothpaste to be dispensed from the toothpaste cartridge (such as the toothpaste cartridge 102) to bristles (such as the one or more bristles 122) of the bristle head attachment. Further, the toothpaste may be dispensed by a servomotor which may apply pressure to the flexible toothpaste cartridge. Further, the sanitizing button may be used for an on-demand sanitizer. Further, the on/off button may be used to activate agitation of the bristle head attachment.

Further, the electric toothbrush 100 may include Indicator lights (such as LEDs) that may be provided on the front surface, which indicate when the electric toothbrush 100 may be operating and/or when the battery may be nearly drained and may need to be recharged. Further, the indicator lights may signal the user if the toothpaste cartridge is empty, and may provide an indicative symbol, such as a smiling emoticon, when the user may be operating the electric toothbrush 100 in the correct position for tooth brushing. Further, in some embodiments, when the upper cap may be closed, a sanitizing feature may be activated for a predetermined period, such as 30 seconds.

Further, to use the electric toothbrush 100, the user may press the toothpaste dispensing button to cause a predetermined quantity of toothpaste to be deposited from the toothpaste cartridge to the bristles of the head attachment. Further, pressing the on/off button, in an instance, may cause the head attachment to begin agitating, at which time the user may release the on/off button. Further, when finished, the user may rinse out the bristles and/or may press the on/off button to deactivate the electric toothbrush 100.

The electric toothbrush 100, in an instance, may be preferably manufactured from rigid, durable materials, such as plastic, copper alloy, steel, and aluminum alloy. Further, the bristles of the head attachment, in an instance, may be preferably manufactured from a semi-rigid, durable material which is easily cleaned, such as nylon.

Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

What is claimed is:

1. An electric toothbrush with a toothpaste cartridge, wherein the electric toothbrush comprises:
a main body having a hollow cylindrical section with a top end and a bottom end, wherein the top end is adapted to engage with a removable brush attachment, wherein the bottom end is adapted to engage with a removable end cap, wherein the main body is configured to accommodate the toothpaste cartridge, one or more conduits, a servo mechanism, a controller, and an energy storage device within the hollow cylindrical section, wherein the servo mechanism is electrically coupled with the energy storage device through the controller, wherein an outer surface of the main body comprises a plurality of control buttons, one or more indicating devices, and a charging socket;
the removable brush attachment having an elongated structure configured to be removably attached to the main body, wherein the elongated structure comprises a first end and a second end, wherein the first end comprises a brush head with a front surface, wherein one or more bristles extend outward from the front surface with one end of the one or more bristles attached to the front surface of the brush head, wherein the front surface comprises one or more openings configured to dispense a fluid flowing through a passage within the removable brush attachment, wherein the passage is adapted to engage with the one or more conduits when the second end of the removable brush attachment is in contact with the top end of the main body; and
the toothpaste cartridge having a flexible cylindrical tank configured for storing the fluid, wherein the toothpaste cartridge is mechanically coupled with the one or more conduits configured to allow the fluid to flow from the toothpaste cartridge to the passage via the one or more conduits, wherein the flexible cylindrical tank is configured to release the fluid into the one or more conduits when a pressure is applied to the toothpaste cartridge by the servo mechanism.

2. The electric toothbrush of claim 1, wherein the servo mechanism comprises a servo motor, and a rack and pinion arrangement, wherein the servo motor is mechanically coupled with the rack and pinion arrangement, wherein the rack and pinion arrangement is configured to convert a rotational motion of the servo motor into a linear motion to apply the pressure to the toothpaste cartridge.

3. The electric toothbrush of claim 1, wherein the fluid comprises a toothpaste.

4. The electric toothbrush of claim 1, wherein the plurality of control buttons comprises at least one of a variable speed button, a sanitizing button, an on/off button, and a toothpaste dispensing button.

5. The electric toothbrush of claim 4, wherein the controller is configured to allow the flow of electrical energy from the energy storage device to the servo mechanism when the toothpaste dispensing button is pressed.

6. The electric toothbrush of claim 1, wherein the one or more indicating devices comprise a display device, wherein the display device is configured to display a visual content, wherein the visual content comprises a smiling emoticon when a user is holding the electric toothbrush in a correct position.

7. The electric toothbrush of claim 6, wherein the display device is configured to display a numerical value corresponding to at least one of a charge amount left in the energy storage device, and a fluid amount left in the toothpaste cartridge.

8. The electric toothbrush of claim 6, wherein the display device comprises at least one of a seven-segment display, a nine-segment display, a fourteen-segment display, and a sixteen-segment display.

9. The electric toothbrush of claim 1, wherein the one or more indicating devices comprise one or more Light Emitting Diodes (LEDs), wherein the one or more LEDs are configured to illuminate one or more colors indicating at least one of an empty toothpaste cartridge, and a drained-out energy storage device.

10. The electric toothbrush of claim 1, wherein the energy storage device comprises at least one of a Lithium-ion battery, a Nickel-Cadmium battery, a Lead-Acid battery, and a Nickel-Metal hydride battery.

11. The electric toothbrush of claim 1, wherein the toothpaste cartridge is manufactured using at least one of plastic, thermoplastic polymers, elastomers, thermoplastic elastomers, and aluminum.

12. The electric toothbrush of claim 1, wherein the main body is manufactured using at least one of a plastic, a copper alloy, a steel, and an aluminum alloy.

13. The electric toothbrush of claim 1, wherein the one or more bristles are manufactured using nylon.

14. The electric toothbrush of claim 1, wherein the removable end cap is configured to secure the toothpaste cartridge within the hollow cylindrical section of the main body.

15. The electric toothbrush of claim 1, wherein the top end of the main body is adapted to engage with a removable upper cap, wherein the removable upper cap is configured to cover the removable brush attachment when the electric toothbrush is not in use.

16. The electric toothbrush of claim 15, wherein the outer surface of the main body comprises a latch configured to removably secure the removable upper cap with the top end of the main body.

17. The electric toothbrush of claim 15, wherein the removable upper cap comprises an Ultraviolet light sanitizer.

18. The electric toothbrush of claim 17, wherein the ultraviolet light sanitizer is electrically coupled with the energy storage device through the controller.

19. The electric toothbrush of claim 18, wherein the controller is configured to allow the flow of electrical energy from the energy storage device to the ultraviolet light sanitizer for a predetermined period when the removable upper cap is engaged with the top end of the main body, wherein the predetermined period is at least 30 seconds.

20. The electric toothbrush of claim 18, wherein the controller is configured to allow the flow of electrical energy from the energy storage device to the ultraviolet light sanitizer when a sanitizing button is pressed, wherein the sanitizing button is disposed on the outer surface of the main body.
